(19) United States
(12) Patent Application Publication
(10) Pub. No.: US 2014/0375647 A1
(43) Pub. Date: Dec. 25, 2014

(54) EFFICIENT REAL-TIME RENDERING FOR HIGH PIXEL DENSITY DISPLAYS

(71) Applicants: Marco Salvi, San Francisco, CA (US); Aaron Lefohn, Bothell, WA (US); Larry Seiler, Boylston, MA (US)

(72) Inventors: Marco Salvi, San Francisco, CA (US); Aaron Lefohn, Bothell, WA (US); Larry Seiler, Boylston, MA (US)

(21) Appl. No.: 13/924,713

(22) Filed: Jun. 24, 2013

(51) Int. Cl. G06T 5/00

(52) U.S. Cl. CPC G06T 5/003
USPC 345/428

(57) ABSTRACT

Methods and systems may provide for obtaining a plurality of visibility samples for an image at a sample resolution, wherein a first subset of the plurality of visibility samples has corresponding color samples. One or more of the color samples may be replicated from the first subset to a second subset of the plurality of visibility samples, and the visibility samples and the color samples may be rendered at a native display resolution. Additionally, the sample resolution may be greater than a pixel resolution of the image and greater than or equal to the native display resolution. In one example, the image includes a plurality of pixels and the plurality of visibility samples are obtained in accordance with an axis-aligned grid within each pixel of the image.

### BACKGROUND

High resolution image rendering may be an integral component of various video applications. In order to reduce the computational and memory bandwidth costs associated with rendering high resolution images, the images may first be rendered at a lower resolution and then scaled up to a target resolution via image post-processing techniques sometimes referred to as “up-sampling”. Although the up-sampling process may produce acceptable results in certain circumstances, such an approach cannot recreate details that were not first rendered at the lower resolution. Accordingly, high definition/resolution edges in the original image content may appear blurry under conventional up-sampling approaches.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an image rendering procedure according to an embodiment;

FIGS. 2A and 2B are illustrations of examples of axis-aligned grids according to embodiments;

FIG. 3 is a flowchart of an example of a method of rendering images according to an embodiment;

FIG. 4 is a block diagram of an example of a logic architecture according to an embodiment;

FIG. 5 is a block diagram of an example of a computing system according to an embodiment;

FIG. 6 is a block diagram of an example of a system having a navigation controller according to an embodiment; and

FIG. 7 is a block diagram of an example of a system having a small form factor according to an embodiment.

### DETAILED DESCRIPTION

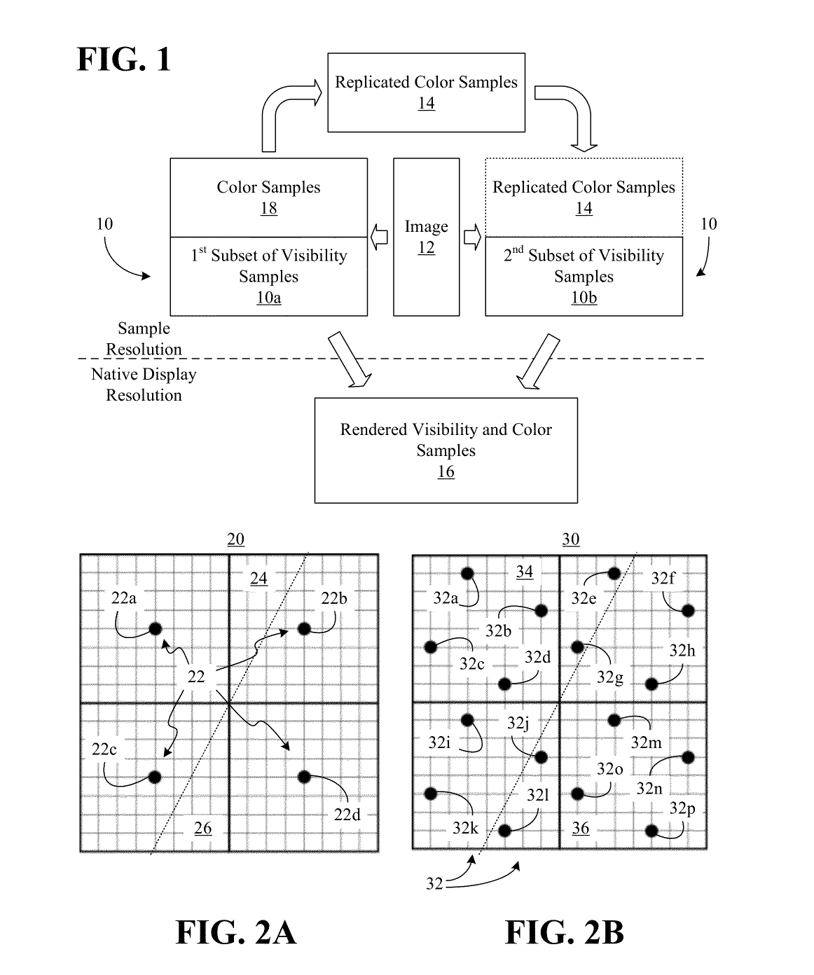

FIG. 1 shows an image rendering procedure in which a plurality of visibility samples 10 (10a, 10b) are obtained for an image 12 at a sample resolution. The image 12 may be associated with a frame of a video signal obtained from an internal/local source such as, for example, an imaging application, game application, memory, cache, etc., and/or an external/remote source such as, for example, a streaming web site, video conferencing service, etc. Additionally, the visibility samples 10 may generally identify the depth of the content (e.g., distance from the viewer) in the image 12 at different locations within the image 12. In this regard, the image 12 may be represented as various primitives (e.g., line segments, curves, triangles), which may in turn be sampled to determine the depth and/or visibility of the primitive in question. The visibility samples 10 may therefore be useful in detecting and reconstructing edges (e.g., primitives or portions of primitives at different depths) in the image 12.

In the illustrated example, a first subset 10a of the visibility samples 10 also has corresponding color samples 18, wherein the color samples 18 of the first subset 10a of the visibility samples 10 are used to obtain/generate replicated color samples 14. The replicated color samples 14 may be assigned to a second subset 10b of the visibility samples 10, wherein the first subset 10a and the second subset 10b may constitute the entirety of the visibility samples 10 for the image 12. Of particular note is that the human vision system may be more sensitive to the high frequency spatial (e.g., within a frame) and temporal (e.g., frame-to-frame) variations presented by edges in images such as the image 12. Accordingly, the sample resolution of the visibility samples 10 may generally be designed to be greater than a pixel resolution of the image 12 and greater than or equal to the resolution of the display (not shown) used to reproduce the image 12 (e.g., the native display resolution). Increasing the sample resolution of the visibility samples 10 in this fashion may enable the recreation of high resolution details that may otherwise be blurry under conventional approaches.

The resolution of the color samples 18, on the other hand, may be significantly less than the resolution of the visibility samples 10. For example, the color samples 18 might be limited to one sample per-pixel per-primitive and assigned to the second subset 10b on a per-pixel, per-primitive basis. Thus, if a particular pixel is covered by a single primitive only one color sample would be made for that pixel, with that color sample being replicated and assigned to all visibility samples for that pixel. If a pixel is covered by two primitives, only two color samples would be made for the pixel, with each color sample being replicated and assigned to the visibility samples for the respective primitive within the pixel. Thus, the first subset 10a of visibility samples 10 may represent the visibility samples for which a color sample is actually made, and the second subset 10b of visibility samples 10 may represent the visibility samples for which a color sample is not made, but replicated. Significant computational and memory bandwidth savings may be realized by reducing the number of color samples as shown.

In the illustrated example, the visibility samples and color samples 16—i.e., the first subset 10a and its corresponding color samples 18 as well as the second subset 10b and its replicated color samples 14—are rendered at the native display resolution. For example, to target a 2K display (2048×1536 pixels), a 1K resolution (1024×768 pixels) image might be rendered with four visibility samples per pixel located over a 2×2 grid within each pixel. Because each X/Y direction has two visibility samples in such a case, the 1K resolution of the image 22 is effectively increased to equal the 2K native display resolution without losing perceptible details in the image 22 as may occur in conventional up-sampling. Simply put, high quality and high resolution images may be generated by rendering the images so that the number of visibility samples per pixel along the X and Y directions multiplied by the pixel resolution matches the native display resolution.

FIG. 2A shows one example of an axis-aligned grid 20 that may be used within each pixel of an image to obtain visibility samples such as the visibility samples 10 (FIG. 1). In general, the axis-aligned grid 20 is a 2×2 configuration that provides for four visibility samples per pixel. Thus, the illustrated axis-aligned grid 20 may enable a 1K resolution image to be effectively increased in resolution to equal a 2K native display resolution without losing perceptible details in the image. The axis-aligned grid 20 may be identical for each pixel of the image, wherein a set of sample locations 22 (22a-22d) define the X,Y position within the pixel at which the visibility samples are made.

In the illustrated example, a first portion 24 of the axis-aligned grid 20 is associated with a first primitive and a second portion 26 of the axis-aligned grid 20 is associated with a second primitive. Accordingly, a visibility sample and a color sample might be taken, for example, at the sample location 22a, and only a visibility sample may be taken at the sample location 22c (or vice versa), with the color sample for the sample location 22a being replicated and assigned to the sample location 22c. Similarly, a visibility sample and a color sample might be taken, for example, at the sample location 22d, and only a visibility sample may be taken at the sample location 22b, with the color sample for the sample location 22d being replicated and assigned to the sample location 22b. Thus, unlike conventional multi-sample anti-aliasing (MSAA), the illustrated approach enables each of the visibility samples to be rendered without a color resolve pass that computes a single per-pixel color in order to display the image on standard display devices.

The sample locations 22 may be positioned so that the sample location 22a is horizontally aligned with the sample location 22b and the sample location 22c is horizontally aligned with the sample location 22d. Similarly, the sample location 22a may be vertically aligned with the sample location 22c and the sample location 22b may be vertically aligned with the sample location 22d. As a result of such an axis alignment, color gradients within the pixels as well as from pixel-to-pixel may be less perceptible to the human eye.

FIG. 2B shows another example of an axis-aligned grid 30 that may also be used within each pixel of an image to obtain visibility samples such as the visibility samples 10 (FIG. 1). In general, the axis-aligned grid 30 is a 4×4 configuration that provides for sixteen visibility samples per pixel. Thus, the illustrated axis-aligned grid 30 may enable a 1K resolution image to be effectively increased in resolution to be greater than a 2K native display resolution without losing perceptible details in the image. As will be discussed in greater detail, a partial resolve pass may be used to match the sample resolution to the native display resolution. The axis-aligned grid 30 may again be identical for each pixel of the image, wherein a set of sample locations 32 (32a-32p) define the X,Y position within the pixel at which the visibility samples are made.

In the illustrated example, a first portion 34 of the axis-aligned grid 30 is associated with a first primitive and a second portion 36 of the axis-aligned grid 30 is associated with a second primitive. Accordingly, a visibility sample and a color sample might be taken, for example, at the sample location 32a, and only a visibility sample may be taken at the sample locations 32b-32d, 32i and 32k, with the color sample for the sample location 32a being replicated and assigned to the sample locations 32b-32d, 32i and 32k. Similarly, a visibility sample and a color sample might be taken, for example, at the sample location 32p, and only a visibility sample may be taken at the sample locations 32f, 32h and 32l-32o, with the color sample for the sample location 32p being replicated and assigned to the sample locations 32f, 32h, and 32l-32o.

In the illustrated example, a partial resolve pass may be used to combine two or more of the color samples for locations 32a-32d, 32i and 32k. A partial resolve may also be used to combine two or more of the color samples for locations 32f, 32h, and 32l-32p. The partial resolve pass may involve averaging or otherwise computing a color value for multiple color samples. Such a resolve pass may be considered partial in the sense that the resulting number of color values may equal the native display resolution rather than a lower resolution that is later up-sampled.

The sample locations 32 may be positioned so that the sample location 32a is horizontally aligned with the sample location 32e, the sample location 32b is horizontally aligned with the sample location 32f, and so forth. Similarly, the sample location 32a may be vertically aligned with the sample location 32i, the sample location 32b may be vertically aligned with the sample location 32j, and so forth. Such an axis alignment enables color gradients within the pixels as well as from pixel-to-pixel to be less perceptible to the human eye, as already noted.

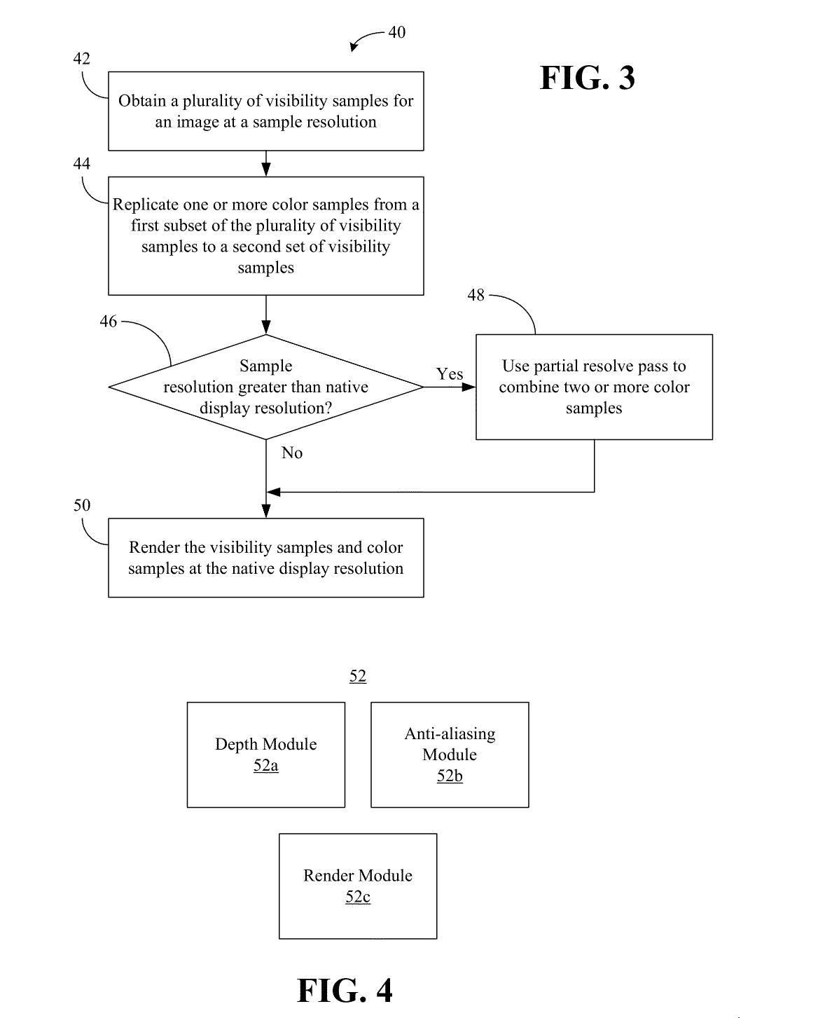

Turning now to FIG. 3, a method 40 of rendering images is shown. The method 40 may be implemented in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 40 may be written in any combination of one or more programming languages, including an object oriented programming language such as Java, Smalltalk, C++ or the like and conventional procedural programming languages, such as the “C” programming language or similar programming languages.

Illustrated processing block 42 provides for obtaining a plurality of visibility samples for an image at a sample resolution. The image may include a plurality of pixels, wherein the visibility samples are obtained in accordance with an axis-aligned grid within each pixel of the image. Moreover, the axis-aligned grid may be identical for each pixel of the image, as already discussed. In one example, a first subset of the plurality of visibility samples has corresponding color samples. One or more of the color samples may be replicated at block 44 from the first subset to a second subset of the plurality of visibility samples, wherein a determination may be made at block 46 as to whether the sample resolution is greater than a native display resolution. If not, the visibility samples and the color samples may be rendered at block 50 without a resolve pass. If, on the other hand, the sample resolution is greater than the native display resolution, illustrated block 48 uses a partial resolve pass to combine two or more color samples. Thus, the partial resolve pass may ensure that the number of color samples equals the native display resolution. As already noted, block 50 may render the visibility samples and the color samples at the native display resolution.

FIG. 4 shows a logic architecture 52 (52a-52c) that is configured to render images according to the techniques described herein. The logic architecture 52 may therefore implement one or more aspects of the method 40 (FIG. 3), already discussed. In the illustrated example, a depth module 52a obtains a plurality of visibility samples for an image at a sample resolution, wherein a first subset of the plurality of visibility samples has corresponding color samples. The architecture 52 may also include an anti-aliasing module 52b that replicates one or more of the color samples from the first subset to a second subset of the plurality of visibility samples. In one example, the replicated color samples are assigned to the second subset on a per-pixel, per-primitive basis.

Additionally, a render module 52c may render the visibility samples and the color samples at a native display resolution, wherein the sample resolution may be greater than a pixel resolution of the image. The sample resolution may also be greater than or equal to the native display resolution. If the sample resolution is greater than the native display resolution, the render module 52c may use a partial resolve pass to combine two or more of the color samples. If the sample resolution is equal to the native display resolution, each of the color samples may be rendered without a resolve pass.

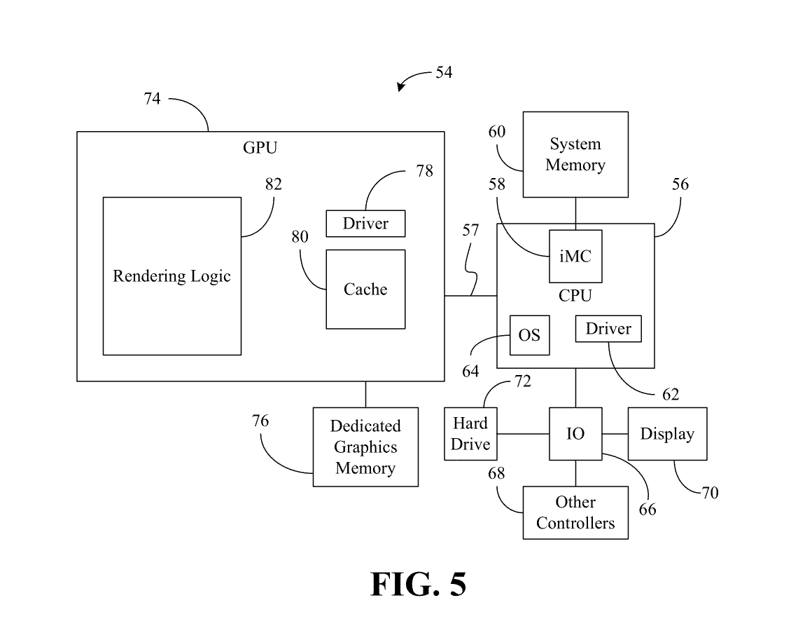

Turning now to FIG. 5, a computing system 54 is shown, wherein the system 54 may be part of a mobile platform such as a laptop, mobile Internet device (MID), personal digital assistant (PDA), media player, imaging device, etc., any smart device such as a smart phone, smart tablet, smart TV (television) and so forth, or any combination thereof. The system 54 may also be part of a fixed platform such as a personal computer (PC), server, workstation, etc. The illustrated system 54 includes a central processing unit (CPU, e.g., main processor) 56 with an integrated memory controller (iMC) 58 that provides access to system memory 60, which could include, for example, double data rate (DDR) synchronous dynamic random access memory (SDRAM, e.g., DDR3 SDRAM JEDEC Standard JESD79-3C, April 2008) modules. The modules of the system memory 60 may be incorporated, for example, into a single inline memory module (SIMM), dual inline memory module (DIMM), small outline DIMM (SODIMM), and so on.

The CPU 56 may also have one or more drivers 62 and/or processor cores (not shown), where each core may be fully functional with instruction fetch units, instruction decoders, level one (L1) cache, execution units, and so on. The CPU 56 could alternatively communicate with an off-chip variation of the iMC 58, also known as a Northbridge, via a front side bus or a point-to-point fabric that interconnects each of the components in the system 54. The CPU 56 may also execute an operating system (OS) 64.

The illustrated CPU 56 communicates with an input/output (IO) module 66, also known as a Southbridge, via a bus. The iMC 58/CPU 56 and the IO module 66 are sometimes referred to as a chipset. The CPU 56 may also be operatively connected to a network (not shown) via a network port through the IO module 66 and various other controllers 68. Thus, the other controllers 68 could provide off-platform communication functionality for a wide variety of purposes such as wired communication or wireless communication including, but not limited to, cellular telephone (e.g., Wideband Code Division Multiple Access, W-CDMA (Universal Mobile Telecommunications System/UMTS), CDMA2000 (IS-856/IS-2000), etc.), Wi-Fi (Wireless Fidelity, e.g., Institute of Electrical and Electronics Engineers/IEEE 802.11, 2007 Edition), Bluetooth (e.g., IEEE 802.15.1-2005, Wireless Personal Area Networks), WiMax (e.g., IEEE 802.16-2004), Global Positioning System (GPS), spread spectrum (e.g., 900 MHz), and other radio frequency (RF) telephony purposes. The IO module 66 may also communicate with a display 70 to provide for the visual output of video, images, and so forth. The other controllers 68 could also communicate with the IO module 66 to provide support for user interface devices (not shown) such as a keypad, mouse, etc., in order to allow a user to interact with and perceive information from the system 54.

The IO module 66 may also have internal controllers such as USB (Universal Serial Bus, e.g., USB Specification 2.0, USB Implementers Forum), Serial ATA (SATA, e.g., SATA Rev. 3.0 Specification, May 27, 2009, SATA International Organization/SATA-IO), High Definition Audio, and other controllers. The illustrated IO module 66 is also coupled to storage, which may include a hard drive 72, read only memory (ROM), optical disk, flash memory (not shown), etc.

The illustrated system 54 also includes a dedicated graphics processing unit (GPU) 74 coupled to a dedicated graphics memory 76. The dedicated graphics memory 74 could include, for example, GDDR (graphics DDR) or DDR SDRAM modules, or any other memory technology suitable for supporting graphics rendering. The GPU 74 and graphics memory 76 might be installed on a graphics/video card, wherein the GPU 74 may communicate with the CPU 56 via a graphics bus 57 such as a PCI Express Graphics (PEG, e.g., Peripheral Components Interconnect/PCI Express x16 Graphics 150W-ATX Specification 1.0, PCI Special Interest Group) bus, or Accelerated Graphics Port (e.g., AGP V3.0 Interface Specification, September 2002) bus. The graphics card may be integrated onto the system motherboard, into the main CPU 56 die, configured as a discrete card on the motherboard, etc. The GPU 74 may also execute one or more drivers 78, and may include an internal cache 80 to store instructions and other data. In one example, the driver 78 is used to program an axis-aligned grid such as, for example, the grid 20 (FIG. 2A) or the grid 30 (FIG. 2B) into the system 54.

The illustrated GPU 74 executes rendering logic 82 that is configured to render images. The rendering logic 82 may have functionality similar to that of the logic architecture 52 (FIG. 4), already discussed. Accordingly, the rendering logic may include a depth module that obtains a plurality of visibility samples for an image at a sample resolution, wherein a first subset of the plurality of visibility samples has corresponding color samples. The rendering logic 82 may also include an anti-aliasing module that replicates one or more of the color samples from the first subset to a second subset of the plurality of visibility samples. In one example, the replicated color samples are assigned to the second subset on a per-pixel, per-primitive basis.

Additionally, a render module may render the visibility samples and the color samples at a native display resolution, wherein the sample resolution may be greater than a pixel resolution of the image. The sample resolution may also be greater than or equal to the native display resolution. If the sample resolution is greater than the native display resolution, the render module may use a partial resolve pass to combine two or more of the color samples. If the sample resolution is equal to the native display resolution, each of the color samples may be rendered without a resolve pass. The display 70 may reproduce the image based on the rendered color samples.

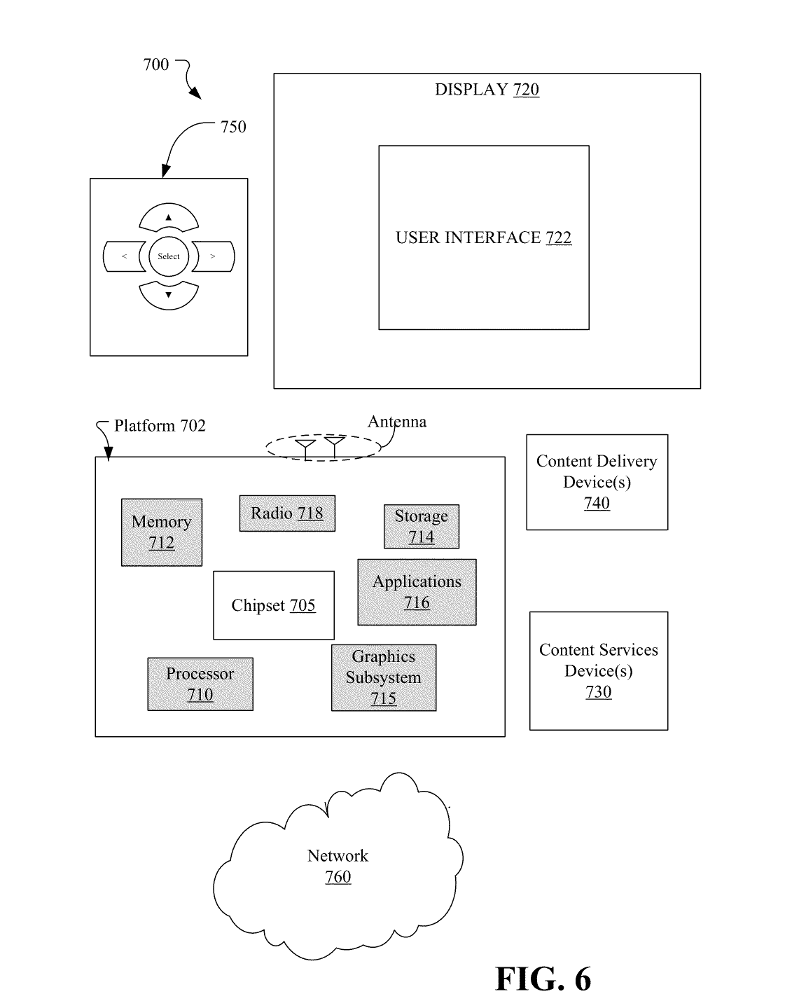

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth. Thus, the system 700 may be used to render images as described herein.

In embodiments, the system 700 comprises a platform 702 coupled to a display 720. Platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. The graphics subsystem 715 may therefore include the GPU 74 (FIG. 5), already discussed. In addition, the processor 710 may be configured to operate as the CPU 56 (FIG. 5), already discussed, via instructions obtained from the memory 712, the storage 714 or other suitable source. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the embodiments.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

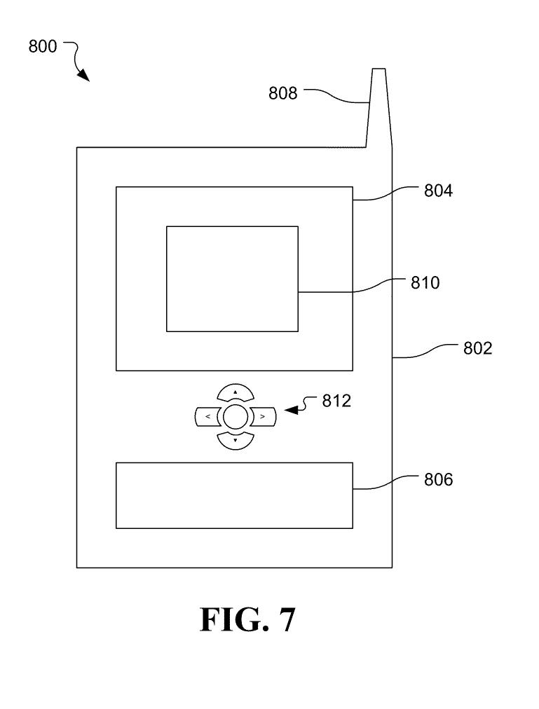

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Additional Notes and Examples:

Example 1 may include a system to render images, comprising a graphics processor. The graphics processor may include a depth module to obtain a plurality of visibility samples for an image at a sample resolution, wherein a first subset of the plurality of visibility samples has corresponding color samples, an anti-aliasing module to replicate one or more of the color samples from the first subset to a second subset of the plurality of visibility samples, and a render module to render the visibility samples and the color samples at a native display resolution, wherein the sample resolution is to be greater than a pixel resolution of the image and greater than or equal to the native display resolution. The system may also include a display to reproduce the image based on the rendered color samples.

Example 2 may include the system of Example 1, wherein the image is to include a plurality of pixels and the plurality of visibility samples are to be obtained in accordance with an axis-aligned grid within each pixel of the image.

Example 3 may include the system of Example 2, wherein the axis-aligned grid is to have a pattern that is identical for each pixel of the image.

Example 4 may include the system of Example 1, wherein the sample resolution is to be greater than the native display resolution, and wherein the anti-aliasing module is to use a partial resolve pass to combine two or more of the color samples.

Example 5 may include the system of Example 1, wherein the sample resolution is to equal the native display resolution, and wherein each of the color samples is to be rendered without a resolve pass.

Example 6 may include the system of any one of claims 1 to 5, wherein the one or more replicated color samples are to be assigned on a per-pixel, per-primitive basis.

Example 7 may include an apparatus to render images, comprising a depth module to obtain a plurality of visibility samples for an image at a sample resolution, wherein a first subset of the plurality of visibility samples has corresponding color samples, and an anti-aliasing module to replicate one or more of the color samples from the first subset a second subset of the plurality of visibility samples. The apparatus may also include a render module to render the visibility samples and the color samples at a native display resolution, wherein the sample resolution is to be greater than a pixel resolution of the image and greater than or equal to the native display resolution.

Example 8 may include the apparatus of Example 7, wherein the image is to include a plurality of pixels and the plurality of visibility samples are to be obtained in accordance with an axis-aligned grid within each pixel of the image.

Example 9 may include the apparatus of Example 8, wherein the axis-aligned grid is to have a pattern that is identical for each pixel of the image.

Example 10 may include the apparatus of Example 7, wherein the sample resolution is to be greater than the native display resolution, and wherein the anti-aliasing module is to use a partial resolve pass to combine two or more of the color samples.

Example 11 may include the apparatus of Example 7, wherein the sample resolution is to equal the native display resolution, and wherein each of the color samples is to be rendered without a resolve pass.

Example 12 may include the apparatus of any one of Examples 7 to 11, wherein the one or more replicated color samples are to be assigned on a per-pixel, per-primitive basis.

Example 13 may include a method of rendering images, comprising obtaining a plurality of visibility samples for an image at a sample resolution, wherein a first subset of the plurality of visibility samples has corresponding color samples, and replicating one or more of the color samples from the first subset to a second subset of the plurality of visibility samples. The method may also provide for rendering the visibility samples and the color samples at a native display resolution, wherein the first sample resolution is greater than a pixel resolution of the image and greater than or equal the native display resolution.

Example 14 may include the method of Example 13, wherein the image includes a plurality of pixels and the plurality of visibility samples are obtained in accordance with an axis-aligned grid within each pixel of the image.

Example 15 may include the method of Example 14, wherein the axis-aligned grid has a pattern that is identical for each pixel of the image.

Example 16 may include the method of Example 13, wherein the sample resolution is greater than the native display resolution, and wherein the method further includes using a partial resolve pass to combine two or more of the color samples.

Example 17 may include the method of Example 13, wherein the sample resolution equals the native display resolution, and wherein each of the color samples is rendered without a resolve pass.

Example 18 may include the method of any one of Examples 13 to 17, wherein the one or more replicated color samples are assigned on a per-pixel, per-primitive basis.

Example 19 may include at least one computer readable storage medium comprising a set of instructions which, if executed by a processor, cause a computing device to obtain a plurality of visibility samples for an image at a sample resolution, wherein a first subset of the plurality of visibility samples has corresponding color samples. The instructions, if executed, may also cause a computing device to replicate one or more of the color samples from the first subset to a second subset of the plurality of visibility samples, and render the visibility samples and the color samples at a native display resolution, wherein the sample resolution is to be greater than a pixel resolution of the image and greater than or equal to the native display resolution.

Example 20 may include the at least one computer readable storage medium of Example 19, wherein the image is to include a plurality of pixels and the plurality of visibility samples are to be obtained in accordance with an axis-aligned grid within each pixel of the image.

Example 21 may include the at least one computer readable storage medium of Example 20, wherein the axis-aligned grid is to have a pattern that is identical for each pixel of the image.

Example 22 may include the at least one computer readable storage medium of Example 19, wherein the sample resolution is to be greater than the native display resolution, and wherein the instructions, if executed, cause a computing device to use a partial resolve pass to combine two or more of the color samples.

Example 23 may include the at least one computer readable storage medium of Example 19, wherein the sample resolution is to equal the native display resolution, and wherein each of the color samples is to be rendered without a resolve pass.

Example 24 may include the at least one computer readable storage medium of any one of Examples 19 to 23, wherein the one or more replicated color samples are to be assigned on a per-pixel, per-primitive basis.

Example 25 may include an apparatus to render images, comprising means for performing the method of any one of Examples 13 to 18.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system to render images, comprising:
a graphics processor including,
a depth module to obtain a plurality of visibility samples for an image at a sample resolution, wherein a first subset of the plurality of visibility samples has corresponding color samples,
an anti-aliasing module to replicate one or more of the color samples from the first subset to a second subset of the plurality of visibility samples, and
a render module to render the visibility samples and the color samples at a native display resolution, wherein the sample resolution is to be greater than a pixel resolution of the image and greater than or equal to the native display resolution; and
a display to reproduce the image based on the rendered color samples.

2. The system of claim 1, wherein the image is to include a plurality of pixels and the plurality of visibility samples are to be obtained in accordance with an axis-aligned grid within each pixel of the image.

3. The system of claim 2, wherein the axis-aligned grid is to have a pattern that is identical for each pixel of the image.

4. The system of claim 1, wherein the sample resolution is to be greater than the native display resolution, and wherein the anti-aliasing module is to use a partial resolve pass to combine two or more of the color samples.

5. The system of claim 1, wherein the sample resolution is to equal the native display resolution, and wherein each of the color samples is to be rendered without a resolve pass.

6. The system of claim 1, wherein the one or more replicated color samples are to be assigned on a per-pixel, per-primitive basis.

7. An apparatus to render images, comprising:
a depth module to obtain a plurality of visibility samples for an image at a sample resolution, wherein a first subset of the plurality of visibility samples has corresponding color samples;
an anti-aliasing module to replicate one or more of the color samples from the first subset to a second subset of the plurality of visibility samples; and
a render module to render the visibility samples and the color samples at a native display resolution, wherein the sample resolution is to be greater than a pixel resolution of the image and greater than or equal to the native display resolution.

8. The apparatus of claim 7, wherein the image is to include a plurality of pixels and the plurality of visibility samples are to be obtained in accordance with an axis-aligned grid within each pixel of the image.

9. The apparatus of claim 8, wherein the axis-aligned grid is to have a pattern that is identical for each pixel of the image.

10. The apparatus of claim 7, wherein the sample resolution is to be greater than the native display resolution, and wherein the anti-aliasing module is to use a partial resolve pass to combine two or more of the color samples.

11. The apparatus of claim 7, wherein the sample resolution is to equal the native display resolution, and wherein each of the color samples is to be rendered without a resolve pass.

12. The apparatus of claim 7, wherein the one or more replicated color samples are to be assigned on a per-pixel, per-primitive basis.

13. A method of rendering images, comprising:
obtaining a plurality of visibility samples for an image at a sample resolution, wherein a first subset of the plurality of visibility samples has corresponding color samples;
replicating one or more of the color samples from the first subset to a second subset of the plurality of visibility samples; and
rendering the visibility samples and the color samples at a native display resolution, wherein the sample resolution is greater than a pixel resolution of the image and greater than or equal to the native display resolution.

14. The method of claim 13, wherein the image includes a plurality of pixels and the plurality of visibility samples are obtained in accordance with an axis-aligned grid within each pixel of the image.

15. The method of claim 14, wherein the axis-aligned grid has a pattern that is identical for each pixel of the image.

16. The method of claim 13, wherein the sample resolution is greater than the native display resolution, and wherein the method further includes using a partial resolve pass to combine two or more of the color samples.

17. The method of claim 13, wherein the sample resolution equals the native display resolution, and wherein each of the color samples is rendered without a resolve pass.

18. The method of claim 13, wherein the one or more replicated color samples are assigned on a per-pixel, per-primitive basis.

19. At least one computer readable storage medium comprising a set of instructions which, if executed by a processor, cause a computing device to:
obtain a plurality of visibility samples for an image at a sample resolution, wherein a first subset of the plurality of visibility samples has corresponding color samples;
replicate one or more of the color samples from the first subset to a second subset of the plurality of visibility samples; and
render the visibility samples and the color samples at a native display resolution, wherein the sample resolution is to be greater than a pixel resolution of the image and greater than or equal to the native display resolution.

20. The at least one computer readable storage medium of claim 19, wherein the image is to include a plurality of pixels and the plurality of visibility samples are to be obtained in accordance with an axis-aligned grid within each pixel of the image.

21. The at least one computer readable storage medium of claim 20, wherein the axis-aligned grid is to have a pattern that is identical for each pixel of the image.

22. The at least one computer readable storage medium of claim 19, wherein the sample resolution is to be greater than the native display resolution, and wherein the instructions, if executed, cause a computing device to use a partial resolve pass to combine two or more of the color samples.

23. The at least one computer readable storage medium of claim 19, wherein the sample resolution is to equal the native display resolution, and wherein each of the color samples is to be rendered without a resolve pass.

24. The at least one computer readable storage medium of claim 19, wherein the one or more replicated color samples are to be assigned on a per-pixel, per-primitive basis.
